(19) United States
(12) Patent Application Publication
(10) Pub. No.: US 2018/0275870 A1
(43) Pub. Date: Sep. 27, 2018

(54) EFFICIENT INTRA-DISK DATA PLACEMENT

(71) Applicant: International Business Machines Corporation, Armonk, NY (US)

(72) Inventors: Itzhack Goldberg, Hadera (IL); Richard Hutzler, Tucson, AZ (US); Gregory T. Kishi, Oro Valley, AZ (US); Neil Sondhi, Pilisborosjeno (HU)

(73) Assignee: International Business Machines Corporation, Armonk, NY (US)

(21) Appl. No.: 15/464,855

(22) Filed: Mar. 21, 2017

(51) Int. Cl. G06F 3/06; G11B 5/012

(52) U.S. Cl. CPC G06F 3/061; G11B 5/012; G06F 3/0689; G06F 3/0631

(57) ABSTRACT

A method for minimizing head seek movement and improving I/O performance of a hard disk drive is disclosed. In one embodiment, such a method includes logically dividing storage space of a hard disk drive into storage areas of substantially equal size. The method monitors a temperature of each of the storage areas. The temperature indicates how frequently data in a corresponding storage area is accessed. The method swaps data in storage areas of the hard disk drive based on temperature. These swaps involve moving hotter data toward outer tracks of the disk drive and colder data toward inner tracks of the disk drive. A corresponding system and computer program product are also disclosed.

### BACKGROUND

### Field of the Invention

This invention relates to systems and methods for minimizing head seek movement and improving I/O performance of hard disk drives.

### Background of the Invention

In today's storage architectures, hard disk drives are used extensively to store data. Such hard disk drives may provide most of the storage in many of today's tiered storage architectures. In such architectures, the “hotness” or “coldness” of data may be continually monitored so that it can be optimally placed on storage media. For example, “hot” (i.e., frequently accessed) data may be placed on faster, more expensive storage media (e.g., solid state drives) to improve I/O performance. “Cold” (i.e., less frequently accessed) data may be placed on slower, less expensive storage media (e.g., hard disk drives) with reduced I/O performance. As the temperature of the data changes, the data may be migrated between storage tiers to optimize I/O performance.

Although significant emphasis has been directed to efficiently placing data on storage tiers of a tiered storage system, little or no emphasis has been directed to efficiently placing data within a hard disk drive itself. As known to those of skill in the art, a hard disk drive typically includes one or more rotating disks (platters) coated with magnetic material. Magnetic heads mounted to a moving actuator arm may be used to read from and write to the platter surfaces. Due to the faster linear velocity of the outer tracks of the platters and the positioning of the heads and actuator arms, reading and writing from the outer tracks is typically must faster than reading and writing data from inner tracks. In some cases, reading and writing to the outer tracks may be four or five times as fast as reading and writing to the inner tracks. For this reason, critical and/or important data such as operating system files may be stored on the outer tracks of a hard disk drive to improve I/O performance.

In view of the foregoing, what are needed are systems and methods to more efficiently place data within a hard disk drive. Ideally such systems and methods will minimize head seek movement and improve I/O performance of the hard disk drive.

### SUMMARY

The invention has been developed in response to the present state of the art and, in particular, in response to the problems and needs in the art that have not yet been fully solved by currently available systems and methods. Accordingly, the invention has been developed to minimize head seek movement and improve the I/O performance of hard disk drives. The features and advantages of the invention will become more fully apparent from the following description and appended claims, or may be learned by practice of the invention as set forth hereinafter.

Consistent with the foregoing, a method for minimizing head seek movement and improving I/O performance of a hard disk drive is disclosed herein. In one embodiment, such a method includes receiving data for writing to a disk array. The method determines a group of tracks of a disk drive to which to write the data. For example, an outer group of tracks may be used to store hotter data and an inner group of tracks may be used to store colder data. The boundary between the outer group of tracks and the inner group of tracks may be adjusted as needed. The method then selects a disk drive in the disk array having a read/write head that is currently reading or writing to the group of tracks. The method then writes the data to the group of tracks on the selected disk drive.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment comprising various types of storage systems;

FIG. 2 is a high-level block diagram showing one embodiment of a storage system comprising an array of storage drives, such as hard disk drives;

FIG. 3 is a high-level diagram showing internal components of a hard disk drive, and more particularly showing dividing a platter of the hard disk drive into two groups of tracks for storing different types of data;

FIG. 4 is a high-level diagram showing dividing a platter of a hard disk drive into additional groups of tracks, in this example three groups;

FIG. 5 is a high-level block diagram showing an intra-disk data placement module that is configured to improve I/O performance to an array of disk drives; and

FIG. 6 is a high-level block diagram showing various sub-modules that may be included within the intra-disk data placement module.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

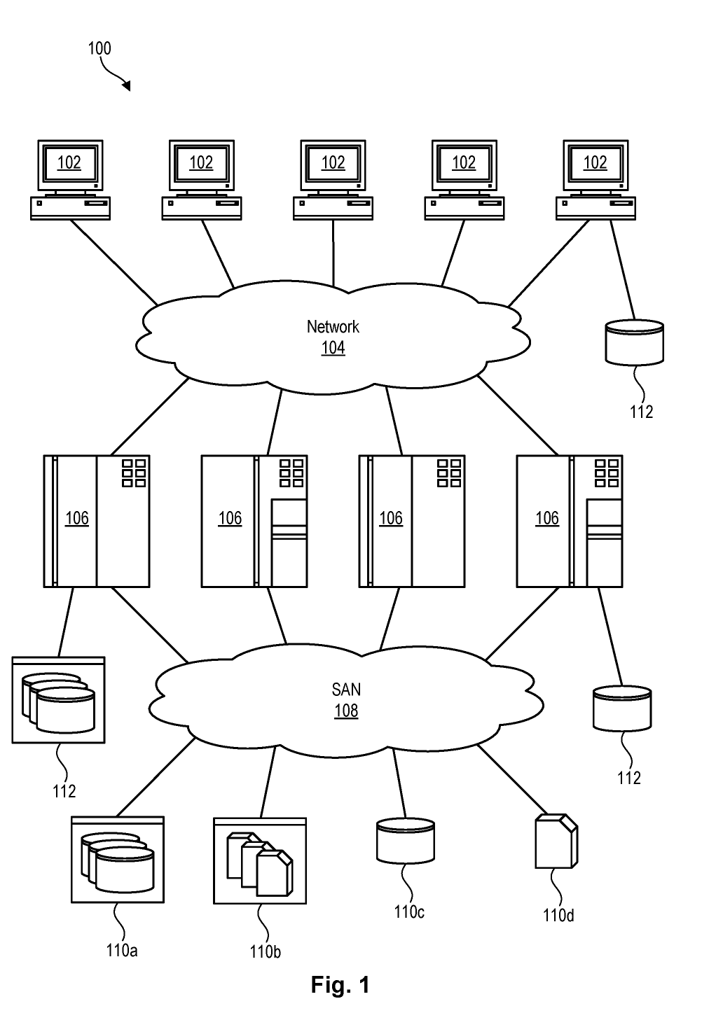

Referring to FIG. 1, one example of a network environment 100 is illustrated. The network environment 100 is presented to show one example of an environment where embodiments of the invention may operate. The network environment 100 is presented only by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 112 (e.g., arrays of hard-storage drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 110, such as arrays 110a of hard-disk drives or solid-state drives, tape libraries 110b, individual hard-disk drives 110c or solid-state drives 110c, tape drives 110d, CD-ROM libraries, or the like. To access a storage system 110, a host system 106 may communicate over physical connections from one or more ports on the host 106 to one or more ports on the storage system 110. A connection may be through a switch, fabric, direct connection, or the like. In certain embodiments, the servers 106 and storage systems 110 may communicate using a networking standard such as Fibre Channel (FC) or iSCSI.

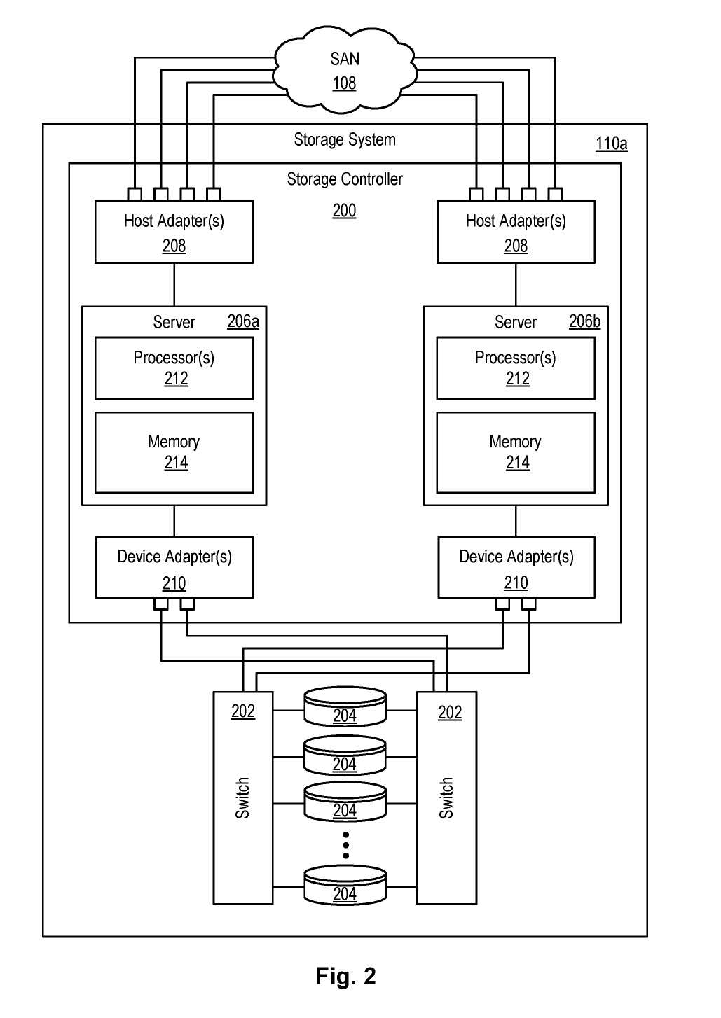

Referring to FIG. 2, one example of a storage system 110a containing an array of hard-disk drives 204 and/or solid-state drives 204 is illustrated. As shown, the storage system 110a includes a storage controller 200, one or more switches 202, and one or more storage drives 204, such as hard-disk drives 204 and/or solid-state drives 204 (e.g., flash-memory-based drives 204). The storage controller 200 may enable one or more hosts 106 (e.g., open system and/or mainframe servers 106) to access data in the one or more storage drives 204.

In selected embodiments, the storage controller 200 includes one or more servers 206. The storage controller 200 may also include host adapters 208 and device adapters 210 to connect the storage controller 200 to host systems 106 and storage drives 204, respectively. Multiple servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage drives 204. The servers 206 may host at least one instance of these software modules. These software modules may manage all read and write requests to logical volumes in the storage drives 204.

One example of a storage system 110a having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the techniques disclosed herein are not limited to the IBM DS8000™ enterprise storage system 110a, but may be implemented in any comparable or analogous storage system 110, regardless of the manufacturer, product name, or components or component names associated with the system 110. Any storage system that could benefit from one or more embodiments of the invention is deemed to fall within the scope of the invention. Thus, the IBM DS8000™ is presented only by way of example and not limitation.

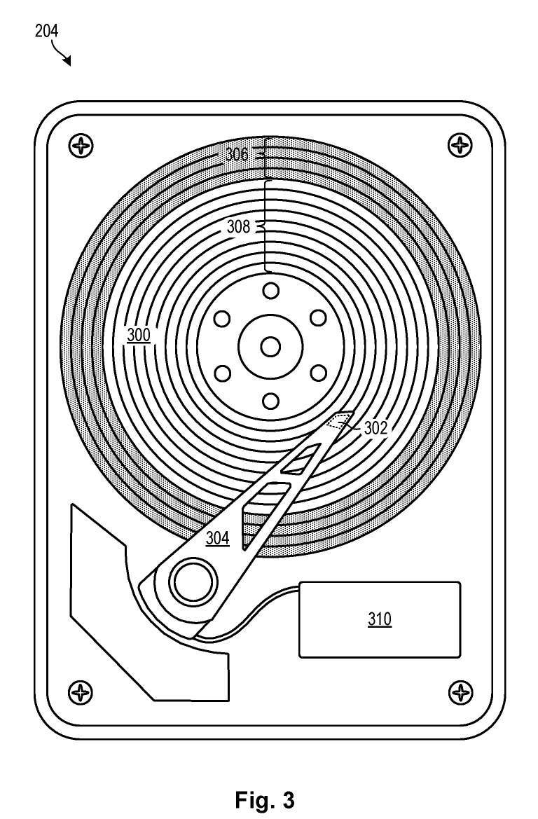

Referring to FIG. 3, a high-level diagram showing internal components of a hard disk drive 204 is illustrated. As known to those of skill in the art, a hard disk drive 204 typically includes one or more rotating disks 300, also referred to as platters 300, coated with magnetic material. Magnetic heads 302 mounted to a moving actuator arm 304 are used to read and write data to the platter surfaces. Due to the circular shape of the spinning platters 300 and the positioning of the heads 302 and actuator arms 304, reading and writing from outer tracks 306 of the spinning platters is typically must faster than reading and writing data from inner tracks 308 of the platters. In some cases, reading and writing to the outer tracks 306 is many times, in some cases four or five times, as fast as reading and writing data to the inner tracks 308.

As further shown in FIG. 3, the hard disk drive 204 may include a controller 310 to enable external components (e.g., a processor) to read from and write to the disk platters 300. This controller 310 may also act as a bus that connects the hard disk drive 204 to external components. The controller's primary function may be to translate instructions received from external components such as processors into signals that can be understood by the hard disk drive's internal components, and vice versa. Instructions from a processor may flow through a hard disk adapter, to a hard disk interface, and then onto the controller 310, which may send commands to internal disk drive components in order to perform a particular operation.

In order to reduce head seek movement and improve I/O performance of the hard disk drive 204, storage space on the platters 300 may be divided up into various groups of tracks (also referred to herein as “zones”). For example, an outer group 306 of tracks (as indicated by the shading) may be designated for storing “hot” data, while an inner group 308 of tracks (as indicated by the lack of shading) may be designated for storing “cold” data. The boundary between the inner group 306 of tracks and the outer group 308 of tracks may be adjusted as needed.

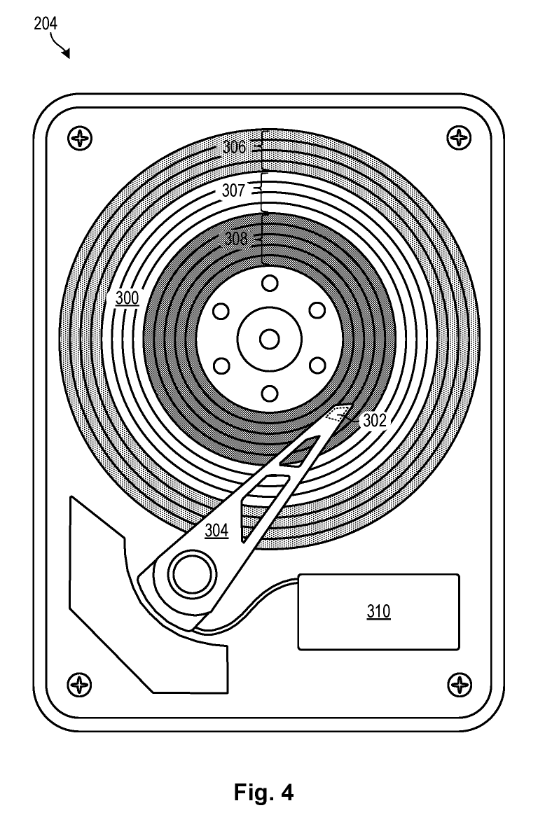

Additional or alternative divisions may be provided on the platters 300. FIG. 4 for example shows a platter 300 that is divided into three groups of tracks, namely an outer group 306 of tracks, an inner group 308 of tracks, and an intermediate group 307 of tracks. Each of these groups of tracks may be designated to store data of a different temperature or range of temperatures. For example, the outer group 306 of tracks may be designated to store “hot” data, the intermediate group 307 of tracks may be designated to store “warm” data, and the inner group 308 of tracks may be designated to store “cold” or archive data.

Alternatively, each of the groups of tracks may be designated to store data by time or events since this data is likely to be accessed together. For example, data that is likely to be accessed at a first time or during a first period (e.g., morning) may be stored in a first group 306, while data that is likely to be accessed at a second time or during a second period (e.g., evening) may be stored in a second group 308. Alternatively, data that is accessed in association with a first scheduled event (e.g., a first sales event for a first set of products) may be stored in a first group 306, while data that is accessed in association with a second schedule event (e.g., a second sales event for a second set of products) may be stored in a second group 308. In this way, data that is accessed at or near the same time (e.g., in close temporal proximity) may be stored in close spatial proximity on the platter 300 to minimize the distance the head 302 and actuator arm 304 must travel to access the data. This will ideally improve I/O performance. Dividing the storage space within a disk drive 204 into different groups of tracks may enable tiered storage to be implemented within a disk drive 204, as well as enable data to be migrated between the tiers as the characteristics (e.g., temperature, etc.) of the data changes.

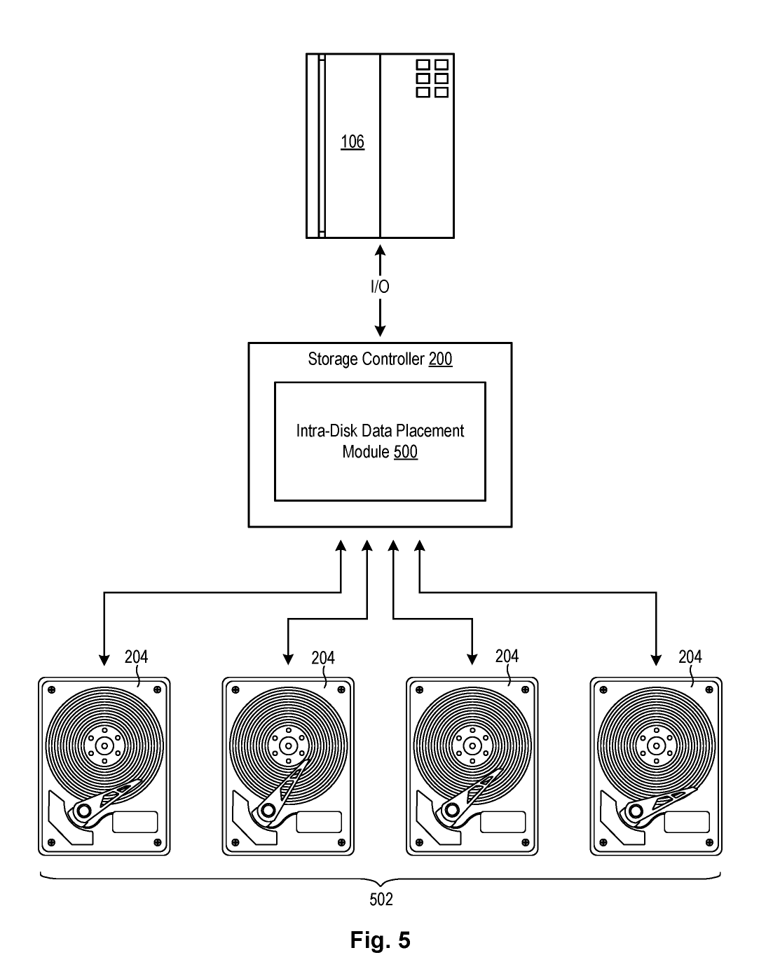

Referring to FIG. 5, in order to reduce the distance a head 302 and actuator arm 304 must travel to write data, an intra-disk data placement module 500 may be provided in the storage controller 200. This intra-disk data placement module 500 may be configured to select, from a disk array 502, a disk drive 204 to which to most efficiently write data. For example, if a storage controller 200 receives data for writing to a disk array 502, the intra-disk data placement module 500 may select a disk drive 204 from the disk array 502 that minimizes movement of a head 302 and/or actuator arm 304. For example, if the data received for writing is “cold,” the intra-disk data placement module 500 may select a disk drive 204 in the disk array 502 that has a head 302 that is currently reading or writing to a group of tracks designated to store “cold” data. This will allow the data to be written to a group of tracks designated for storing “cold” data while minimizing movement of a head 302 and actuator arm 304.

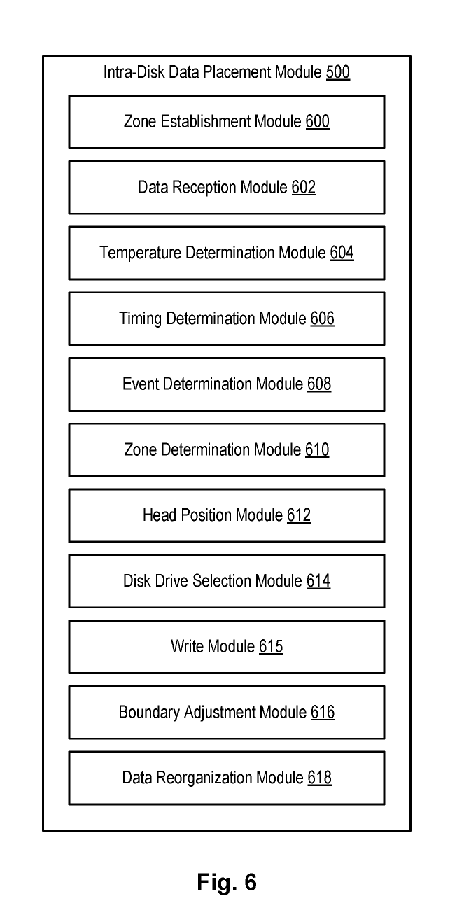

Referring to FIG. 6, in order to implement the functionality of the intra-disk data placement module 500, the intra-disk data placement module 500 may include various sub-modules. These sub-modules may be implemented in hardware, software, firmware, or combinations thereof. These sub-modules may include one or more of a zone establishment module 600, data reception module 602, temperature determination module 604, timing determination module 606, event determination module 608, zone determination module 610, head position module 612, disk drive selection module 614, write module 615, boundary adjustment module 616, and data reorganization module 618. The intra-disk data placement module 500 may include more or fewer modules than those illustrated, or the functionality of the modules may be combined or split into additional modules as needed.

As shown, the zone establishment module 600 may be configured to establish various zones (i.e., groups of tracks) on a disk drive platter 300. For example, a first zone, which may be made up of outer tracks, may be used to store “hot” data, and a second zone, which may be made up of inner tracks, may be used to store “cold” data. Other zones or divisions of storage space on the platter 300 are possible and within the scope of the invention.

The data reception module 602 may receive data to be written to a disk array 502 and a temperature determination module 604 may determine a temperature of the data. In certain embodiments, temperature information may be received with data from the host system 106 (as part of a write command, for example) or the temperature determination module 604 may analyze historical I/O statistics on the host system 106 and/or the storage system 110a to determine the temperature of the data.

Alternatively to determining the temperature of the data, the timing determination module 606 may determine timing associated with the data. That is, the timing determination module 606 may determine timing (e.g., evenings, mornings, weekdays, weekends, etc.) when the data will likely be accessed. This may enable the data to be placed on a disk drive 204 near other data that will likely be accessed at the same or similar time, thereby reducing head seek movement of the disk drive 204 on which the data is stored.

Alternatively to determining the temperature or timing associated with the data, the event determination module 608 may determine scheduled events associated with the data. In other words, the event determination module 608 may determine scheduled events that may correspond in time to needed access of the data. This may enable the data to be placed on the disk drive 204 near other data that will be accessed in association with the same scheduled event or events, thereby reducing head seek movement of the disk drive 204 on which the data is stored.

Once an associated temperature, timing, or scheduled event is determined for data to be written, the zone determination module 610 may determine an appropriate zone (i.e., group of tracks) on which to store the data. The head position module 612 may then determine the current head position for disk drives 204 in the disk array 502. In certain embodiments, this may be accomplished by analyzing data that is currently being read from or written to the disk drives 204 and determining if this data is located at or near the same location or group of tracks to which the received data needs to be written (based on its associated temperature, timing, event, etc.). In other embodiments, disk drives 204 may be configured to provide information to a storage controller 200 that indicates where the heads 302 of the disk drives 204 are currently positioned.

Based on the head position of each of the disk drives 204, the disk drive selection module 614 may select a disk drive 204 that has a head positioned at or near the tracks that the received data is designated to be written. In some cases, this may be the disk drive 204 whose head 302 is positioned closest to the tracks that the received data is designated to be written. The write module 615 may then write the data to the designated tracks or group of tracks on the selected disk drive 204.

The boundary adjustment module 616 may be configured adjust the boundary between zones (i.e., groups of tracks) as needed. In certain embodiments, this may occur dynamically as the need for storage space in each zone changes. The data reorganization module 618, by contrast, may be configured to reorganize data within a disk drive 204 or across disk drives 204. For example, as the temperature of data changes, the data may be migrated from one zone to another. In certain cases, this may include moving the data from one disk drive 204 to another if, for example, another disk drive 204 is currently reading or writing to a zone that is appropriate to store the data. This will ideally reduce or minimize head seek movement. In certain cases, this may cause the boundary adjustment module 616 to adjust the boundary between zones since the amount of storage space needed in each zone may change.

The flowcharts and/or block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for minimizing head seek movement and improving I/O performance in a disk drive, the method comprising:
receiving data for writing to a disk array;
determining a group of tracks of a disk drive to which to write the data;
selecting a disk drive in the disk array having a read/write head that is currently reading or writing to the group of tracks; and
writing the data to the group of tracks on the selected disk drive.

2. The method of claim 1, wherein determining a group of tracks of a disk drive comprises determining a temperature of the data.

3. The method of claim 2, wherein determining a group of tracks of a disk drive comprises determining a group of tracks that store data of the same temperature.

4. The method of claim 1, wherein the group of tracks are a group of outer tracks of the disk drive.

5. The method of claim 1, wherein the group of tracks are a group of inner tracks of the disk drive.

6. The method of claim 1, further comprising adjusting which tracks belong to the group of tracks.

7. The method of claim 6, wherein adjusting comprises dynamically adjusting as a need for storage space in the group of tracks changes.

8. A computer program product for minimizing head seek movement and improving I/O performance in a disk drive, the computer program product comprising a computer-readable medium having computer-usable program code embodied therein, the computer-usable program code configured to perform the following when executed by at least one processor:
receive data for writing to a disk array;
determine a group of tracks of a disk drive to which to write the data;
select a disk drive in the disk array having a read/write head that is currently reading or writing to the group of tracks; and
write the data to the group of tracks on the selected disk drive.

9. The computer program product of claim 8, wherein determining a group of tracks of a disk drive comprises determining a temperature of the data.

10. The computer program product of claim 9, wherein determining a group of tracks of a disk drive comprises determining a group of tracks that store data of the same temperature.

11. The computer program product of claim 8, wherein the group of tracks are a group of outer tracks of the disk drive.

12. The computer program product of claim 8, wherein the group of tracks are a group of inner tracks of the disk drive.

13. The computer program product of claim 8, wherein the computer-usable program code is further configured to adjust which tracks belong to the group of tracks.

14. The computer program product of claim 13, wherein adjusting comprises dynamically adjusting as a need for storage space in the group of tracks changes.

15. A system for minimizing head seek movement and improving I/O performance in a disk drive, the system comprising:
at least one processor;
at least one memory device coupled to the at least one processor and storing instructions for execution on the at least one processor, the instructions causing the at least one processor to:
receive data for writing to a disk array;
determine a group of tracks of a disk drive to which to write the data;
select a disk drive in the disk array having a read/write head that is currently reading or writing to the group of tracks; and
write the data to the group of tracks on the selected disk drive.

16. The system of claim 15, wherein determining a group of tracks of a disk drive comprises determining a temperature of the data.

17. The system of claim 16, wherein determining a group of tracks of a disk drive comprises determining a group of tracks that store data of the same temperature.

18. The system of claim 15, wherein the group of tracks are one of a group of outer tracks and a group of inner tracks of the disk drive.

19. The system of claim 15, wherein the instructions further cause the at least one processor to adjust which tracks belong to the group of tracks.

20. The system of claim 19, wherein adjusting comprises dynamically adjusting as a need for storage space in the group of tracks changes.
